(19) United States
(12) Patent Application Publication
(10) Pub. No.: US 2011/0192357 A1
(43) Pub. Date: Aug. 11, 2011

(54) ANIMAL PAD

(76) Inventor: Neena Pellegrini, Tacoma, WA (US)

(21) Appl. No.: 12/701,804

(22) Filed: Feb. 8, 2010

(51) Int. Cl. A01K 23/00; A01K 29/00

(52) U.S. Cl. 119/850

(57) ABSTRACT

One embodiment provides an animal pad having an elongated planar strap with a first and second coupling end that are configured to couple. Additionally the elongated planar strap further includes an elongated pad portion by the first coupling end and an elongated thong portion between the pad portion and the second coupling end, the thong portion having a width less than the width of the pad portion. Some embodiments of the dog pad include a tail orifice.

### FIELD

The present disclosure relates to animal garments, and specifically to systems and methods for providing an animal pad.

### BACKGROUND

Having domestic pets is immensely popular. For example, recent surveys indicate that 45.6 million households in the United States have at least one dog, and that the total population of domestic dogs is approximately 77.5 million in the United States. Another survey found that half of all American pet owners consider their pets as much a part of the family as any person in the household; an additional 36 percent said their pet is part of the family but not a full member.

Accordingly, many breeds of dogs, especially those living in urban areas, spend a majority of their time indoors. Pets can be trained to urinate and defecate in a manner that is suitable to an owner. For example, house-bound cats are typically trained to use a litter box and house-bound dogs can be trained to wait until they are allowed outside by their owners. However, despite being domesticated, some pets may still urinate indoors or other undesired locations. Similarly, female pets that are not spayed may create a mess when menstruating.

Additionally, many dog enthusiasts enjoy “showing” their dogs, which includes entering them into contests and pageants to judge how well the dog meets the standards of their breed. Additionally, dogs may also be judged on obedience and agility, which may include tests of their ability to maneuver and perform various tasks.

Certain breeds of dogs have high-maintenance coats or hair. For example, coated dogs such as poodles, Portuguese water dogs, Irish water spaniels, and bichon frise are prone to having their coats crushed by contact or by grooming. Additionally, dogs with lots of hair can also have high maintenance coats including chow chows, Siberian huskies, Samoans, Alaska malamutes, and the like.

For such breeds, grooming can be expensive and labor intensive. This is especially true for show dogs, which typically need daily grooming. Show poodles are one of the most labor and time-intensive breeds to groom. For example, it may take up to two years to grow a poodle coat to the length needed for competition, and this coat is fragile and prone to damage from even minimal contact. Because the distinctive poodle coat is so important to the presentation of the dog, their hair is considered precious and must be protected at all times.

Contact with urine or other bodily fluids is one way that a dog's coat can be damaged. As one solution, various animal diapers or animal pads have been designed to be worn by animals to prevent such undesired accidents. For example, FIG. 1 is a depiction of dog underwear 10. (Produced by Pants For Dogs LLC of Tacoma, Wash., www.PantsForDogs.com).

Unfortunately, such products are not suitable to be worn by certain dogs with high-maintenance coats because they can crush or matt a large portion of a dog's coat while dog underwear 10 is being worn. Show dog owners do not want animal garments that will crush or otherwise spoil the costly grooming of their dog, yet at the same time need protection against the dog ruining its grooming through accidental contact with bodily fluids from the dog itself or other animals.

Additionally, the dog underwear 10 is less than ideal for active dogs because it hinders freedom of movement and can be uncomfortable and cumbersome for dogs to wear. For example, as depicted in FIG. 1, the dog underwear 10 covers a large portion of the rear of the dog 100, which hinders movement while the dog 100 is walking or running.

### SUMMARY

One embodiment provides an animal pad having an elongated planar strap with a first and second coupling end that are configured to couple. Additionally the elongated planar strap further includes an elongated pad portion by the first coupling end and an elongated thong portion between the pad portion and the second coupling end, the thong portion having a width less than the width of the pad portion. Some embodiments of the animal pad include a tail orifice.

In further embodiments, a dog pad is configured to be worn by a dog such that the first and second coupling end are configured to snugly couple about the torso of the dog, the thong portion is configured to snugly abut the rear back of the dog extending parallel to the spine of the dog, and the pad portion extending between the legs of the dog and configured to snugly cover at least one of the urethra, anus or vagina of the dog.

### BRIEF DESCRIPTION OF THE DRAWINGS

FIG. 1 is an illustration of a dog wearing an animal pad as currently known in the art.

FIG. 2 is an illustration of a show-poodle wearing an animal pad in accordance with an embodiment of the present invention.

FIG. 3 is an illustration of the back of show-poodle depicting a regulation show poodle continental clip with rosettes.

FIG. 4a is an illustration of the outer surface of an animal pad in accordance with an embodiment.

FIG. 4b is an illustration of the inner surface of an animal pad in accordance with the same embodiment depicted in FIG. 4a.

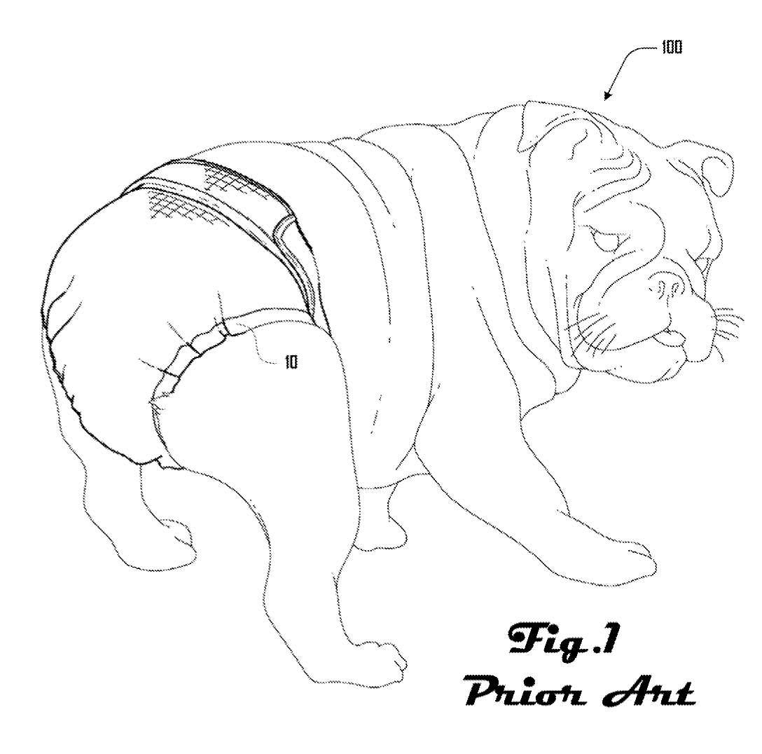

### DETAILED DESCRIPTION

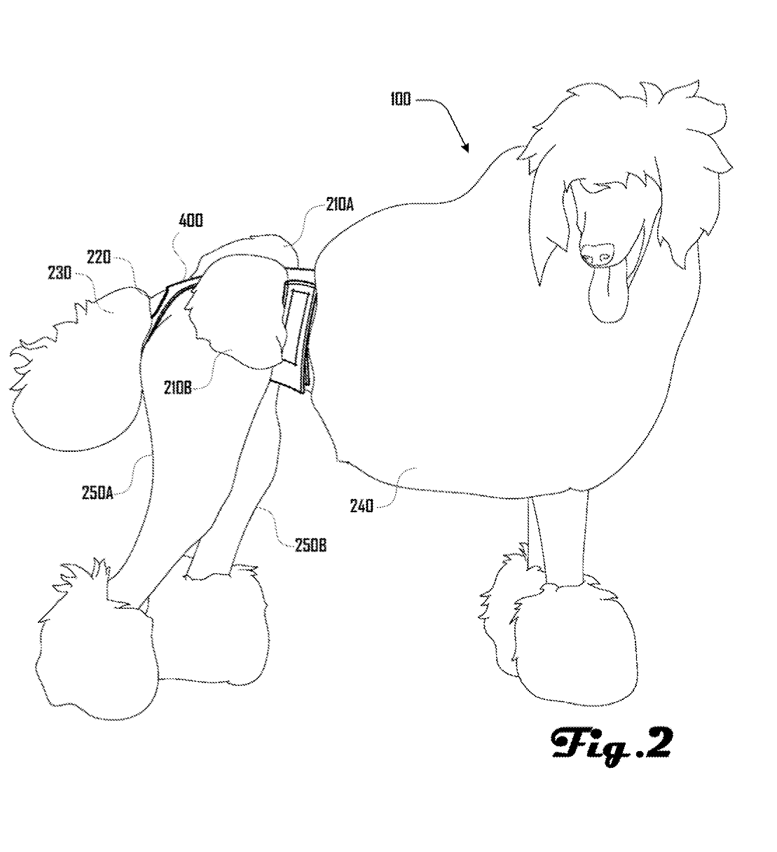

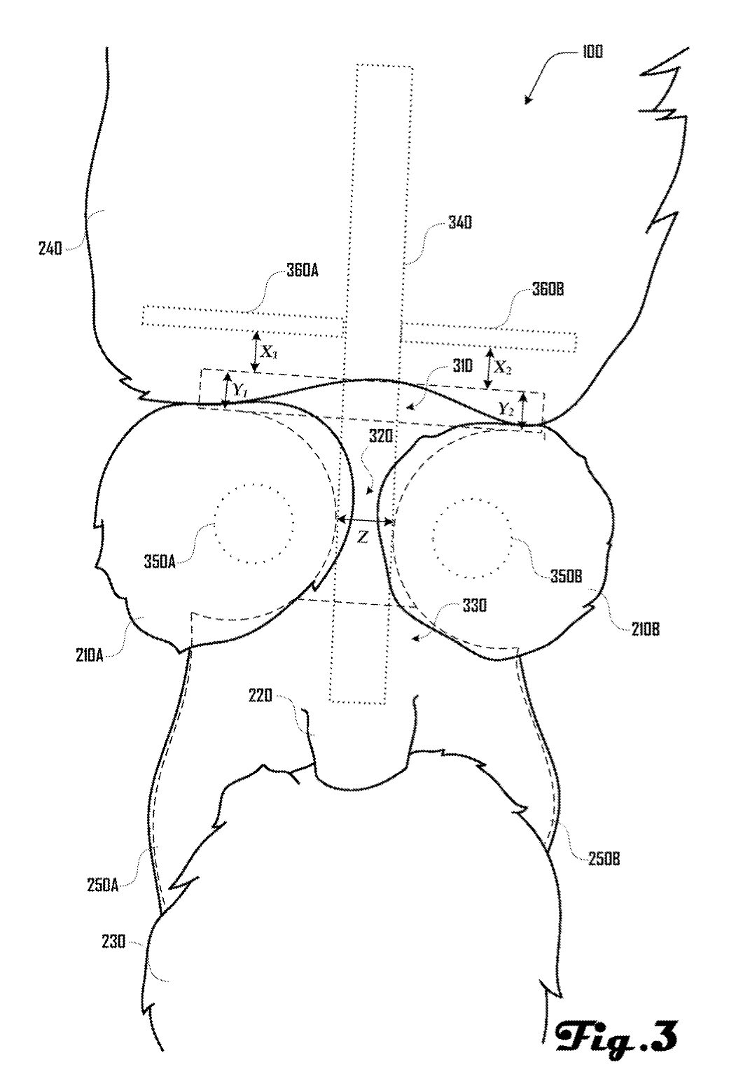

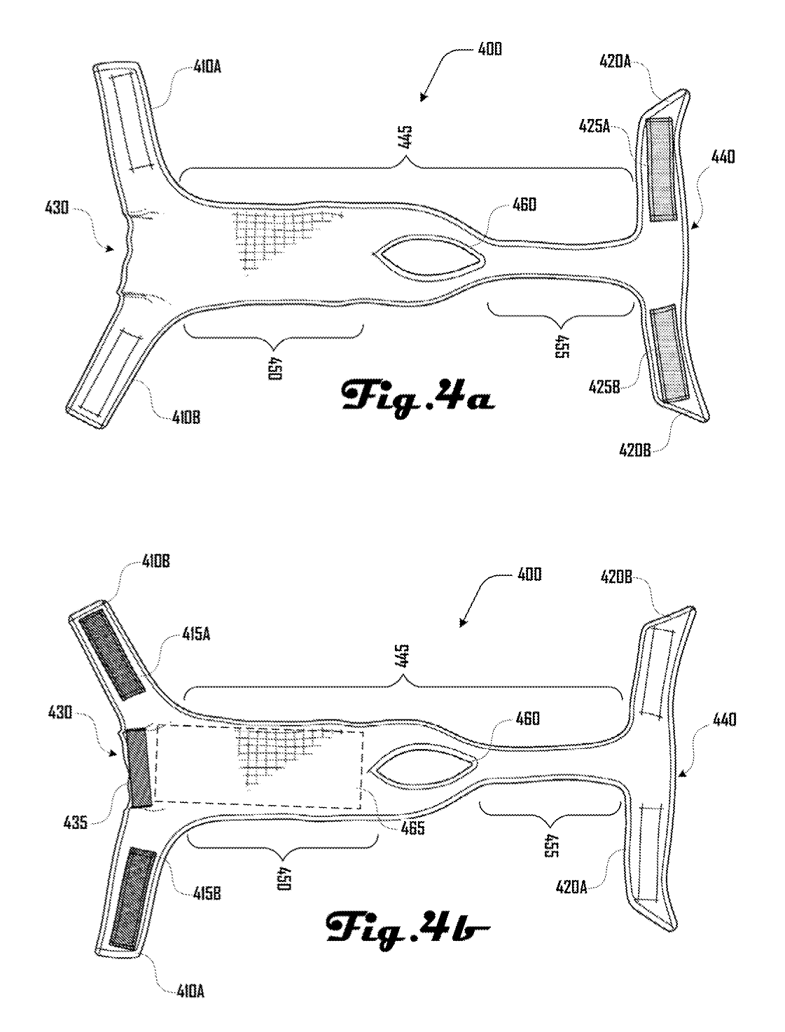

Now referring to FIG. 2, a show-poodle 100 is depicted wearing an animal pad 400 (FIGS. 4a and 4b) in accordance with an embodiment. The show-poodle 100 is depicted in a regulation continental show clip, which includes a first and second rosette 210A, 210B located on the left and right hip joint 350A, 350B (FIG. 3) of the left and right leg 250A, 250B respectively. The tail 220 includes a tail-pom 230. The regulation continental show clip also includes a pack portion 240.

As depicted in FIG. 2, the continental show clip is defined by shaving portions of the show-poodle 100 coat to create features of the show clip. Portions of the show-poodle 100 may be closely or entirely shaven and other portions may remain.

Now referring to FIG. 3, the back of the show-poodle 100 is depicted, showing further detail of the continental show clip and including features depicted in FIG. 2. Also, shown in dotted lines, are the position of the spine 340; the left and right terminal rib 360A, 360B; and left and right hip joint 350A, 350B. Additionally, the dashed lines indicate perimeters of the boundary between shaved coat portions and portions where coat hair is remaining.

The pack portion 240 is illustrated, extending a distance X past the terminal ribs 360. A hemispherical left rosette 210A is located on the left hip joint 350A, and a hemispherical right rosette 210B is located on the right hip joint 350A. The pack portion 240 and rosettes 210 are separated by a rosette-pack strip 310, which extends perpendicular to the spine 340 and parallel to the terminal ribs 360 of the show-poodle 100. The shortest distance between a rosette 210 and the pack 240 is distance Y.

The right and left rosettes 210A, 210B are located symmetrically on either side of the spine 340, which is the central axis of the show poodle 100. The shortest distance between the rosettes 210A, 210B is depicted as distance Z, and the area between the rosettes 210 and about the spine 340 is a rosette-cleavage strip 320, which extends parallel to the spine 340. Beyond the rosettes 210 is a shaved rump-portion 330, which further defines the continental show clip and extends down the legs 250. The tail 220 is also depicted having a tail-porn 230.

According to the American Kennel Club (www.akc.org) and the United Kennel Club (www.ukcDogs.com), adult show-poodles must be shown with a regulation continental clip, which may or may not include rosettes 210. However, the continental clip with rosettes is the more popular version of the continental clip.

For a regulation continental clip, the face, front legs between leg-poms and elbow, hind quarter to the tail-porn area and with the exception of the hip rosettes, feet, and base of tail are all shaved closely. The pack area 240 is left long and cut into shape. The end of the tail coat is also left long and cut to be a spherical tail-porn 230. Poms on the legs begin shortly above the wrist and hock joints and terminate just above the feet. They are also cut round. The hip rosettes 210 are placed directly over the hip joints 350. The rosettes 210 are 0.5-1.0 inches apart (depending upon the variety of poodle) and are cut hemispherical. The pack 240 ends 0.5-1.0 inches behind the last ribs. There is 0.5 inches between the end of the pack and the beginning of the hip rosettes.

Accordingly, referring to FIG. 3, for a regulation continental cut with rosettes 210, the length of X is 0.5-1.0 inches; the length of Y is 0.5 inches and the length of Z is 0.5-1.0 inches. However, it should be appreciated that continental show clips may not be exactly conforming, and that any of these lengths X, Y and Z may be approximate. Additionally, it should be appreciated that the regulations of show-poodle continental cuts may change, and that the dimensions associated with a regulation show clip may be different.

In various embodiments, it may be desirable to provide a dog pad 400 (FIG. 4) that can be worn by a show poodle 100 having a regulation continental clip with rosettes 210, which minimally contacts or interferes with fur of the show-poodle 100 such as the pack 240, rosettes 210 and the like. Accordingly, a dog pad 400 may be configured to be worn by a show poodle 100 and primarily contact the rosette-pack strip 310, rosette-cleavage strip 320, shaved rump-portion 330, or other shaved portion of a show-poodle 100 having a continental clip, with or without rosettes 210. For example, FIG. 2 depicts a show-poodle wearing such a dog pad 400, in accordance with an embodiment.

In further embodiments, it may be desirable to provide a dog pad 400, which allows a dog to have freedom of movement and be minimally constricted or obstructed by the dog pad 400. Accordingly, in some embodiments, a dog pad 400 may be provided that comprises a thong portion 455 (FIG. 4), which extends along the center of the back of the dog having minimal width. For example, a desirable width of a thong portion 455 in accordance with one embodiment may be less than or equal to the width of the spine 340 of a dog, and configured to reside on the spine 340.

Additionally, in a further embodiment, a desirable width of a thong portion 455 may be such that the thong portion 455 extends along the spine 340 of the dog and is of a width such that the thong portion 455 extends between, and does not contact the hip joints 350 of the dog. In a still further embodiment, it may be desirable to minimize portions of an animal pad 400 such that there is minimal contact with, and therefore interference with the legs 250 of a dog. The following FIGS. 4a and 4b depict an embodiment of animal pad 400 that may conform to such characteristics.

FIGS. 4a and 4b depict an animal pad 400 in accordance with an embodiment. FIG. 4a depicts the outside surface of the animal pad 400 and FIG. 4b depicts the inside surface of the animal pad 400 (i.e. the surface that abuts an animal when the animal pad 400 is worn by an animal).

The animal pad 400 comprises an elongated portion 445, and a first and second coupling end 430, 440. The elongated portion 445 comprises a pad portion 450, a thong portion 455, and a tail orifice 460. The pad portion 450 abuts the first coupling end 430, and the thong portion 455 abuts the second coupling end 440. The tail orifice 460 is disposed between the thong portion 455 and the pad portion 450. In various embodiments, the thong portion 455 has a width that is less than the width of the pad portion 450.

The pad portion 450 is configured to cover at least one of the urethra, anus or vagina of the dog or other animal, when the animal pad 400 is worn by an animal. In various embodiments, the animal pad 400 is configured to be worn snugly such that there is snug coverage of least one of the urethra, anus or vagina of a dog or other animal that is wearing the animal pad 400.

Additionally, the inside surface of the animal pad 400 as shown in FIG. 4b includes a pad coupling surface 465, which is shown by a dotted box. The pad coupling surface 465 and pad portion 450 may be configured to couple an absorbent pad or the like. An absorbent pad may be coupled via hook and loop tape, an adhesive, or the like, or may simply be held by the pad portion 450 when the animal pad 400 is worn by an animal. The animal pad 400 may also include one or more elastic band 430, which provides support or retain an absorbent pad or is configured to shape a portion of the animal pad 400. Such absorbent pads may be disposable and replaceable, and may include known commercial pads or diapers.

For example, dogs and other animals are prone to urination and menstruation in situations where contact or exposure to such animal fluids is less than desirable. Pets living in a home can have difficulty or inability to control their bodily functions, and may make a mess in the home, on furniture, on people, and the like. Accordingly, these animals may wear an animal pad to capture the results of urination and menstruation should it occur.

In another example, animals such as show-dogs may also suffer from similar lack of control of bodily discharges, which may result in harm to the coat of the dog. Because show dog grooming is time consuming and expensive, even a small amount of urine or menstrual fluid can destroy an expensive show grooming. An animal pad in accordance with various embodiments described and shown herein may prevent ruining of a dog's show grooming.

Referring again to FIGS. 4a and 4b, the first coupling end 430 may comprise a left first-coupling-end coupling arm 410A and a right first-coupling-end coupling arm 410B. The second coupling end 440 may comprise a left second-coupling-end coupling arm 420A and a right second-coupling-end coupling arm 420B.

In various embodiments the left first-coupling-end coupling arm 410A and left second-coupling-end coupling arm 420A are configured to couple via complementary hook and loop tape 410A, 420A. Also, the right first-coupling-end coupling arm 410A and right second-coupling-end coupling arm 420B are configured to couple via complementary hook and loop tape 410A, 420A.

In some embodiments the first and second coupling end 430, 440 may be various shapes and sizes, which are capable of coupling, and such coupling may achieved by any suitable coupling means, such as a pin, adhesive, tying, clips and the like.

The animal pad 400 may be worn by a dog 100 as depicted in FIG. 2. For example, the animal pad 400 may be placed on dog 100, with its tail 220 extending through the tail orifice 460. The thong portion 455 may extend along the spine 340 and the pad portion 450 may extend under the tail 230, between the legs 250 to cover one or more of the urethra, anus or vagina of the dog.

The first and second coupling ends 430, 400 can be coupled by wrapping the respective coupling arms 410, 420 around the torso of the dog 100 and coupling the respective coupling arms 410, 420 via the complementary hook and loop strips 410, 420. In various embodiments, the animal pad 400 is held snugly against the body of the dog 100 in such a configuration. Additionally, an absorbent pad can be coupled about the pad coupling surface 465, and may be selectively removed.

Additionally, in various embodiments the animal pad 400 may comprise various materials and fabrics. The inside and outside faces (FIGS. 4a and 4b respectively) may be made of different materials. For example, the inside face of the animal pad 400 may be made of fleece or other soft material suitable for contact with an animal's skin or fur. Additionally, various portions of the animal pad 400 may include elastic. For example, there may be elastic members within the perimeter of the pad portion, which provide support for an absorbent pad or which facilitate a snug fit of the animal pad 400.

From the foregoing it will be appreciated that, although specific embodiments have been described herein for purposes of illustration, various modifications may be made without deviating from the spirit and scope of the disclosure. Furthermore, where an alternative is disclosed for a particular embodiment, this alternative may also apply to other embodiments even if not specifically stated.

1. A dog pad comprising:
an elongated planar strap comprising:
a first coupling end;
a second coupling end, the first and second coupling ends configured to couple;
an elongated pad portion proximate to the first coupling end; and,
an elongated thong portion between the pad portion and the second coupling end, the thong portion having a width less than the width of the pad portion,
wherein the dog pad is configured to be worn by a dog such that the first and second coupling end are configured to snugly couple about the torso of the dog, the thong portion is configured to snugly abut the rear back of the dog extending parallel to the spine of the dog, and the pad portion extending between the legs of the dog and configured to snugly cover at least one of the urethra, anus or vagina of the dog.

2. The dog pad of claim 1 further comprising a tail orifice between the thong portion and the pad portion, wherein the tail of the dog extends through the tail orifice when the dog pad is worn by the dog.

3. The dog pad of claim 1, further comprising an absorption pad coupled to the pad portion.

4. The dog pad of claim 3, further comprising an elastic retaining band on the pad portion configured to support the absorption pad.

5. The dog pad of claim 1,
wherein the first coupling end comprises a left first-coupling-end coupling arm; and a right first-coupling-end coupling arm,
wherein the second coupling end comprises a left second-coupling-end coupling arm; and a right second-coupling-end coupling arm,
wherein the left first-coupling-end coupling arm and left second-coupling-end coupling arm are configured to couple; and
wherein the right first-coupling-end coupling arm and right second-coupling-end coupling arm are configured to couple.

6. The dog pad of claim 1, wherein the coupling ends are configured to couple and encircle the torso of a dog approximately 0.5 to 1.0 inches behind the terminal rib of the dog and having a width approximately 0.5 inches or less.

7. The dog pad of claim 6, wherein the elongated thong portion is configured to be centered about the spine of the dog, extending between a right and left rosette positioned approximately 1.0 inches to 1.5 inches behind a right and left terminal rib of the dog respectively, and the elongated thong portion having a width portion approximately less than 0.5 to 1.0 inches configured to extend between the left and right rosette, which are approximately 0.5 to 1.0 inches apart and approximately equidistant from the spine of the dog.

8. The dog pad of claim 6, wherein a second coupling end, comprising a left second-coupling-end coupling arm and a right second-coupling-end coupling arm, are configured to be coupled and encircle the torso of a dog approximately 0.5 to 1.0 inches behind the terminal rib of the dog and the left second-coupling-end coupling arm and a right second-coupling-end coupling arm both having a width of approximately 0.5 inches or less.

9. A dog pad configured couple at a first and second coupling end and be worn by a dog having a regulation continental show-clip wherein the dog pad is configured to be worn by a dog such that the first and second coupling end are configured to snugly couple about the torso of the dog, and a thong portion is configured to snugly abut the rear back of the dog extending parallel to the spine of the dog, and a pad portion extending between the legs of the dog and configured to snugly cover at least one of the urethra, anus or vagina of the dog, and wherein the dog pad is configured to substantially only contact portions of the dog that are substantially shaved.

10. The dog pad of claim 9, wherein the continental show clip comprises rosettes.

11. The dog pad of claim 9 further comprising a tail orifice between the thong portion and the pad portion, wherein the tail of the dog extends through the tail orifice when the dog pad is worn by the dog.

12. The dog pad of claim 9, further comprising an absorption pad coupled to the pad portion.

13. The dog pad of claim 12, further comprising an elastic retaining band on the pad portion configured to support the absorption pad.

14. The dog pad of claim 9, wherein the width of the thong portion is less than the width of the pad portion.

15. A dog pad configured to provide freedom of movement while a dog is wearing the dog pad, wherein the dog pad is configured to be worn by a dog such that a first and second coupling end are configured to snugly couple about the torso of the dog, and a thong portion is configured to snugly abut the rear back of the dog extending parallel to the spine, and having a width not greater than the spine of the dog, and a pad portion extending between the legs of the dog and configured to snugly cover at least one of the urethra, anus or vagina of the dog.

16. The dog pad of claim 15 further comprising a tail orifice between the thong portion and the pad portion, wherein the tail of the dog extends through the tail orifice when the dog pad is worn by the dog.

17. The dog pad of claim 15, further comprising an absorption pad coupled to the pad portion.

18. The dog pad of claim 17, further comprising an elastic retaining band on the pad portion configured to support the absorption pad.

19. The dog pad of claim 15, wherein the width of the thong portion is less than the width of the pad portion.
